(19) United States
(12) Patent Application Publication
(10) Pub. No.: US 2004/0079402 A1
(43) Pub. Date: Apr. 29, 2004

(54) Car equipped with self-washing device

(76) Inventor: Kyoung-Ju Shin, Yongin-Shi (KR)

Correspondence Address: Peter T. Kwon, G W i P S, Kanagnam, P. O. Box 2301, Seoul, 135-242, TW

(21) Appl. No.: 10/686,654

(22) Filed: Oct. 17, 2003

(30) Foreign Application Priority Data
Oct. 23, 2002 (KR) 2002-0031559

(51) Int. Cl. B08B 3/00

(52) U.S. Cl. 134/123; 134/172; 134/179; 134/184; 134/198

(57) ABSTRACT

Disclosed is a car capable of self-washing by the driving force of the car. An air compressor for generating air flow and a steam generation device are installed to operate by the accessory power of the car's engine. Inhalation and discharge holes are formed for inhaling and discharging air, and a separate vacuum accessory or injector may be combined to the hole, selectively. Thus, only a small amount of water is required for washing the car by steam without a cleansing solution, thereby eliminating wasted water and preventing environmental pollution together with no restriction of washing space. Time and costs are reduced compared to conventional washing. In winter, the steam generation device allows washing without water freezing, and ensures sufficient visibility for safe driving by eliminating frost. The vacuum accessory may be used for cleaning the inside of the car, so a user may always maintain the car clean and optimize car functions.

### BACKGROUND OF THE INVENTION

1. Field of the Invention

The present invention relates to a car capable of washing itself by use of the driving force of the car, and more particularly to a car with a self-washing device which operates an air compressor and a steam generation device by the accessory power of the car's engine so that the car may be washed by itself using inhalation and discharge of the compressor and steam made by the steam generation device.

2. Description of the Related Art

Generally, when driving a car, dust and impurities adhere to the inside and outside of the car even if a driver makes efforts to avoid it. The dust and impurities deteriorate the appearance of the car, and dust and impurities inside the car may make car passengers feel uncomfortable. Thus, a driver usually cleans the inside and outside of his/her own car periodically.

To wash a car, a driver generally uses service water and a cleansing solution at home.

However, washing a car at home needs a great amount of water and cleansing solution, which may cause environmental problems due to unnecessary water consumption and the pollution generated by chemicals contained in the cleansing solution. Moreover, since people dwell densely in recent years such as in an apartment, it is very difficult to wash a car at or near a house.

Due to such difficulties, a driver usually drives to a car wash for washing the car.

However, to wash a car in the car wash, the car needs to be moved to the car wash, which is troublesome and causes an unnecessary waste of time. In addition, due to the charge for washing a car in the car wash, it is economically not efficient.

In addition, washing a car may be impossible in the winter since the water may be frozen.

### SUMMARY OF THE INVENTION

The present invention is designed to solve such problems of the prior art, and therefore an object of the invention is to provide a car capable of self-washing by use of its own engine's power, in which an air compressor for generating air flow and a steam generation device are mounted in the car, an inhalation hole and a discharge hole are formed in the car for inhalation and discharge of the air, to which separate inhaler and injector accessories may be optionallyattached.

This car with a self-washing device is capable of being washed by steam with a small amount of water without any need of a cleansing solution, thereby reducing wasted water and resultant environmental pollution. In addition, the car with a self-washing device does not require a large space for the washing, so a driver need not move to a car wash, which allows the driver to reduce time and costs for washing.

In addition, the steam generation device makes it possible to wash the car without water even in the winter and eliminate frost so that a driver may maintain a sufficient visibility for safe driving. Moreover, since the inside of the car may be cleaned with the use of the inhaler, a driver may always clean and manage the car so that the car may operate optimally.

### BRIEF DESCRIPTION OF THE DRAWINGS

Other objects and aspects of the present invention will become apparent from the following description of embodiments with reference to the accompanying drawing in which:

FIG. 1 is a perspective view showing an engine compartment according to the present invention;

FIG. 2 is a side view for illustrating a car according to the present invention; and

FIG. 3 is a schematic view for illustrating the operation of the car according to the present invention.

### DESCRIPTION OF THE PREFERRED EMBODIMENT

Hereinafter, a preferred embodiment of the present invention is described in detail with reference to the accompanying drawings.

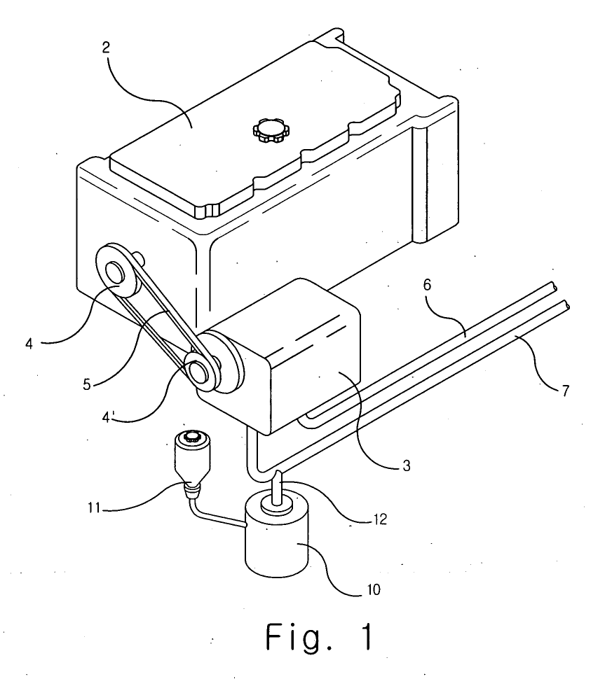

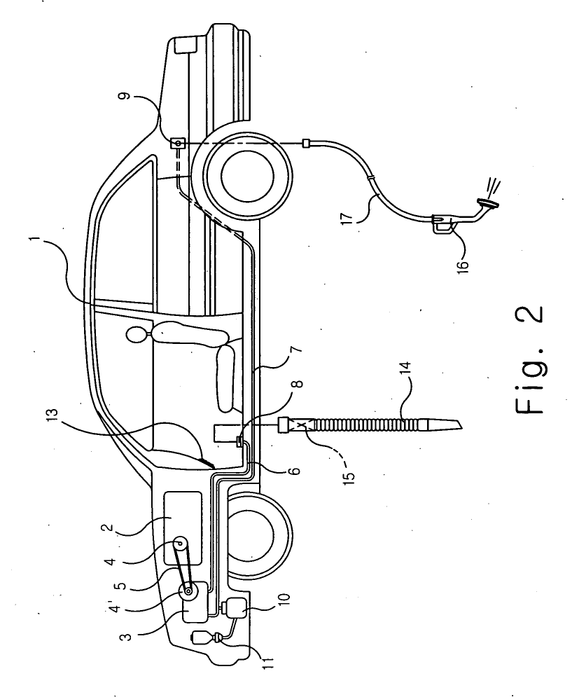

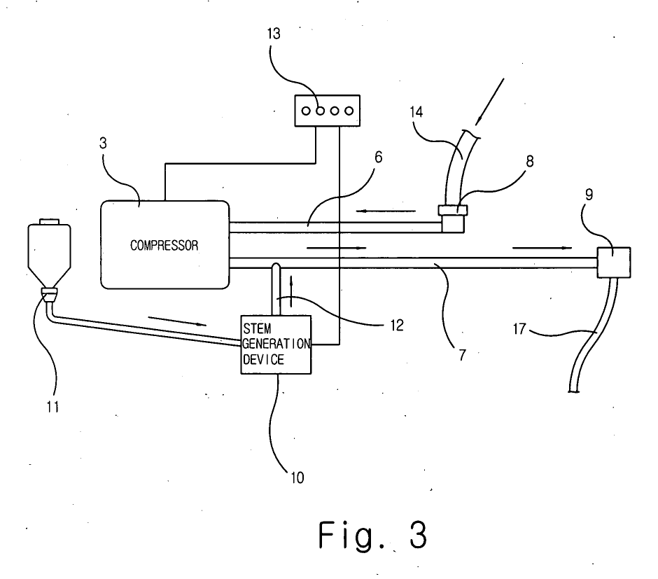

FIG. 1 is a perspective view showing that a self-washing device of the present invention is mounted to an engine of a car, FIG. 2 is a side view for illustrating the side of the car, and FIG. 3 is a schematic view showing an operating state of the self-washing device according to the present invention.

A car has an engine 2 and a compressor 3 to which belt pulleys 4 and 4′ are respectively combined so as to ensure power transmission between the engine 2 and the compressor 3 via a belt 5. The compressor 3 is also connected to an inhalation hole 8 and a discharge hole 9 which are respectively formed inside and outside of the car 1 by means of an inhalation pipe 6 and a discharge pipe 7. A steam generation device 10 combined with a water supply unit 11 is combined to the discharge pipe 7 through a steam supply pipe 12. The car 1 also has a switch 13 for the above components.

As shown, a vacuum accessory 14 provided with a filter 15 is attached to the inhalation hole 8, while an injector 16 provided with a connection hose 17 is attached to the discharge pipe 9.

Now, the operation of the above-described device is described in detail with reference to the drawings.

When washing a car equipped with the self-washing device of the present invention, a user operates the switch 13 mounted near the driver seat of the car 1 so that the power is transmitted from the engine 2 to the compressor 3. Then, air is inhaled through the inhalation hole 8 formed near the driver seat, and then the air flows into the compressor 3 through the inhalation pipe 6, thereby generating air pressure to be discharged.

The high pressure air in the compressor 3 is then discharged through the discharge hole 9 via the discharge pipe 7. As shown, if the injector 16 connected to the separate connection hose 17 is attached to the discharge hole 9, it is possible to inject steam.

In this case, water is supplied to the steam generation device 10 through the water supply unit 11. The steam generation device 10 is a commonly used steam generation device equipped with a heater. If the steam generation device 10 generates steam, the steam is supplied toward the discharge pipe 7 through the steam supply pipe 12. The steam is then injected outward by the injector 16 attached to the discharge hole 9 through the discharge pipe 7 together with the air, thereby making it possible to wash the car 1 by use of the steam.

In order to supply water used for generation of steam, a user may easily fill water into the water supply unit 11 at any place.

In addition, when cleaning the inside of the car 1 by using the self-cleaning device of the car 1, a user combines the separate vacuum accessory 14 to the inhalation hole 8 formed near the driver seat. Then, the inhaler 14 may be used as a vacuum cleaner capable of inhaling dust or impurities in the car.

The inhaler 14 is provided with the detachable filter 15 so as to prevent impurities from being ingested into the compressor 3.

For the above operation, the compressor 3 is connected to a separate ON/OFF switch in order to reduce unnecessary idling of the compressor 3. In addition, by using an electric signal of the switch 13 mounted near the driver seat of the car 1, a user may operate, control and check the compressor 3 and the steam generation device 10.

Since the washing device using steam according to the present invention allows washing the car by itself, it is possible to decrease water consumption and eliminate even smudged dirt by use of the steam. In addition, the device allows easy washing at any time.

The self-washing device is capable of washing a car with steam using only a small amount of water without any need of a cleansing solution, thereby reducing wasted water and resultant environmental pollution. In addition, the car with a self-washing device does not require a large space for the washing procedure, so a driver need not move to a car wash, which allows the driver to reduce time and costs for washing.

In addition, the steam generation device makes it possible to wash the car without water even in the winter and eliminate frost so that a driver may maintain sufficient visibility for safe driving. Moreover, since the inside of the car may be cleaned with the use of the inhaler, a driver may always clean and manage the car so that the car may operate optimally.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A car equipped with a self-washing device comprising:
an engine and a compressor to which belt pulleys are respectively attached, said engine and said compressor being connected via a belt for power transmission therebetween,
said compressor being connected to an inhalation hole and a discharge hole respectively formed inside and outside of the car through an inhalation pipe and a discharge pipe respectively;
a steam generation device equipped with a water supply unit, said steam generation device being combined to the discharge hole by means of a steam supply pipe; and
a switch mounted in the car for operating said compressor.

2. The car equipped with a self-washing device according to claim 1, further comprising a vacuum accessory provided with a filter which can optionally be attached to the inhalation hole.

3. The car equipped with a self-washing device according to claim 1, further comprising an injector having a connection hose which can optionally be attached to the discharge hole.
